(19) United States
(12) Patent Application Publication
(10) Pub. No.: US 2007/0078594 A1
(43) Pub. Date: Apr. 5, 2007

(54) Navigation system and vehicle position estimating method

(76) Inventor: Daishi Mori, Tokyo (JP)

Correspondence Address: BRINKS HOFER GILSON & LIONE, P.O. BOX 10395, CHICAGO, IL, 60610, US

(21) Appl. No.: 11/541,465

(22) Filed: Sep. 29, 2006

(30) Foreign Application Priority Data
Sep. 30, 2005 (JP) 2005-286755

(51) Int. Cl. G01C 21/00

(52) U.S. Cl. 701/207; 701/211; 701/41

(57) ABSTRACT

A turning direction calculating unit determines a turning direction of a vehicle based on a change in azimuth of the vehicle. An angular velocity calculating unit calculates an angular velocity of the vehicle. A turning radius calculating unit calculates a turning radius of the vehicle by using the angular velocity and a travel distance of each predetermined time period. A turning radius correcting unit corrects the turning radius so that the turning radius becomes larger by a correction value WL according to a traveling position on a road if the vehicle turns to the left, and corrects the turning radius so that the turning radius becomes smaller by a correction value WR according to a traveling position on a road if the vehicle turns to the right. A vehicle position estimating unit estimates a vehicle position on a center line of the road by using the corrected turning radius.

### RELATED APPLICATIONS

The present application claims priority to Japanese Patent Application Number 2005-286755, filed Sep. 30, 2005, the entirety of which is hereby incorporated by reference.

### BACKGROUND OF THE INVENTION

1. Field of the Invention

The present invention relates to a navigation system and a vehicle position estimating method. Particularly, the present invention relates to a navigation system and a vehicle position estimating method for accurately estimating a position of a vehicle by using signals output from a self-contained navigation (SCN) sensor.

2. Description of the Related Art

In a navigation system, map data corresponding to a present position of a vehicle is read from a map data storing unit, such as a DVD (digital versatile disc) or an HDD (hard disk drive), and is displayed on a display. A vehicle position mark is moved on the map in accordance with the travel of the vehicle, or the vehicle position mark is fixed at a certain position of the display (e.g., the center of the display) and the map is scrolled.

The map data includes (1) a road layer including node data, road link data, and intersection data; (2) a background layer for displaying objects on the map; and (3) a text layer for displaying names of cities, towns, and villages. An image of the map to be displayed on the display is generated on the basis of the background layer and the text layer. A map matching process and a process of searching for a guiding route are performed on the basis of the road layer.

In such a navigation system, it is essential to measure a present position of the vehicle. For this purpose, self-contained navigation (SCN), which is a method for measuring a vehicle position by using a vehicle-mounted SCN sensor including a distance sensor and an azimuth sensor (gyro), and satellite navigation, which is a GPS (global positioning system) measuring method using a GPS satellite, have been generally used.

Recent vehicle-mounted navigation systems use the SCN and the satellite navigation in parallel. Typically, the position and azimuth of the vehicle are estimated by the SCN, and the estimated vehicle position is corrected by a map matching process (combination of pattern matching and projection), so that an actual position of the vehicle on a road is obtained. If the map matching process based on pattern matching becomes impossible to be performed for some reason, the map matching process is initialized and the position measured by the GPS is set as the position of the vehicle. Thereafter, the position and azimuth of the vehicle are estimated by the SCN. At the same time, the map matching process starts and the estimated vehicle position is corrected to an actual position on a road.

In the SCN, a vehicle position is estimated in the following manner by accumulating the output from a distance sensor and a relative azimuth sensor (see Japanese Unexamined Patent Application Publication No. 2004-226341). FIG. 18 is an illustration of a known vehicle position estimating method based on the SCN. In this method, a distance sensor outputs a pulse every time the vehicle runs a predetermined distance. Accordingly, a traveling velocity V of the vehicle can be measured by counting pulses generated in each unit time. Herein, a reference azimuth (θ=0) is a positive direction of the X axis, and the counterclockwise direction with respect to the reference azimuth is a positive direction. If the previous vehicle position is a point P0 (X0, Y0), if the absolute azimuth in a traveling direction of the vehicle at the point P0 is θ0, and if an output from the relative azimuth sensor at a travel distance L0 (=Vxt) after unit time t is Δθ1, a change of the vehicle position can be expressed by the following expressions:
ΔX=L0·cos(θ0+Δθ1); and
ΔY=L0·sin(θ0+Δθ1).

An estimated azimuth θ1 in the traveling direction of the vehicle at a point PI and an estimated vehicle position (X1, Y1) can be calculated by vector synthesis according to the following expressions:
θ1=θ0+Δθ1 (1);
X1=X0+ΔX=X0+L0·cos θ1 (2); and
Y1=Y0+ΔY=Y0+L0·sin θ1 (3).

Therefore, by providing an absolute azimuth and position coordinates of the vehicle at a start point by GPS, the vehicle position can be detected (estimated) in real time by repeating the calculation of expressions (1) to (3) every time the vehicle runs a unit distance.

In the SCN, however, errors accumulate as the vehicle runs, and thus an estimated vehicle position may deviate from a road. Thus, the estimated vehicle position is compared with the road data in a map matching process so that the estimated position is corrected to an actual position on the road.

FIG. 19 is an illustration of map matching based on a projection method. Assume that a present vehicle position is a point Pi-1 (Xi-1, Yi-1) and that a vehicle azimuth is θi-1 (in the figure, the point Pi-1 deviates from a road RDa). If a relative azimuth after the vehicle has run a travel distance LO (=Vxt) from the point Pi-1 is Δθi, an estimated vehicle position Pi′ (Xi′, Yi′) and an estimated vehicle azimuth θi at Pi′ according to the SCN can be calculated by the following expressions:
θi=θi−1+Δθ1;
Xi′=Xi−1+L0·cos θi; and
Yi′=Yi−1+L0·sin θi.

At this time, (a) a link (an element constituting a road) satisfying the following conditions is searched for. That is, it is included in a 200 meters square with the estimated vehicle position Pi′ being the center, and a perpendicular can extend to the link. Also, an angle defined by the estimated vehicle azimuth θi at the estimated vehicle position Pi′ and the link is within a predetermined value (e.g., within 45°), and the length of the perpendicular extending from the estimated vehicle position Pi′ to the link is within a predetermined value (e.g., 100 m). Herein, a link LKa1 (a straight line extending between nodes Na0 and Na1) of an azimuth θa1 on the road RDa and a link LKb1 (a straight line extending between nodes Nb0 and Nb1) of an azimuth θb1 on the road RDb are found.

Then, (b) the lengths of perpendiculars RLia and RLib extending from the estimated vehicle position Pi′ to the links LKa1 and LKb1 are calculated.

Then, (c) a coefficient Z is calculated in accordance with the following expressions:
Z=dL·20+dθ·20 (dθ≦25°) (4); and
Z=dL·20+dθ·40(dθ>25°) (4)′.

Herein, dL represents the length of the perpendicular extending from the estimated vehicle position Pi′ to the link (the distance from the estimated vehicle position to the link), and dθ represents an angle defined by the estimated vehicle azimuth θi and the link. The weight coefficient is larger as the angle dθ is larger.

(d) After the coefficient Z has been obtained, a link satisfying the following conditions is searched for:

(1) distance dL≦75 m (maximum attractive distance of 75 m);

(2) angular difference dθ≦30° (maximum attractive angle of 30° ); and

(3) coefficient Z≦1500.

The link whose coefficient is the minimum is regarded as a matching candidate (optimum road). Herein, the link LKa1 is selected.

(e) Then, a track SHi extending between the point Pi-1 and the point Pi′ is moved parallel along the perpendicular RLia until the point Pi-1 comes onto the link LKa1 (or onto an extension of the link LKa1), and moved points PTi-1 and PTi′ of the points Pi-1 and Pi′ are obtained.

(f) Finally, the point PTi′ is pivoted onto the link LKa1 (or onto the extension of the link LKa1) with the point PTi-1 being the center of rotation and the moved point thereof is obtained, and the moved point is regarded as an actual vehicle position Pi (Xi, Yi). The vehicle azimuth at the actual vehicle position Pi (Xi, Yi) remains θi. As shown in FIG. 20, when the previous vehicle position Pi-1 is on the road RDa, the moved point PTi-1 matches the point Pi-1.

FIGS. 21A to 23 are illustrations of map matching based on pattern matching. In the pattern matching, a track (position and azimuth of each predetermined time period or each predetermined travel distance obtained by the SCN) is stored, a road on a map having the same shape as that of the track is obtained, and a vehicle mark is map-matched to a point on the road. When matching between a track pattern and a candidate road pattern is performed, segment-chain approximation using equal-length segments is performed on the pattern of the track LP as shown in FIG. 21A, and candidate roads existing in a predetermined area around the vehicle are detected. Then, as shown in FIG. 21B, segment-chain approximation is performed on the pattern of each candidate road RP. Then, as shown in FIG. 22, a track LP′ is moved parallel so that the start position of the segment-chain-approximated track LP′ comes to the start position of the segment-chain-approximated candidate road RP′, and the track LP′ is rotated by a predetermined angle θ (at first 0°). Under this condition, the sum of distances between corresponding points (pi, qi) and (li, mi) of the road RP′ and the track LP′ is calculated (i=1, 2, . . . n). Then, the sum of distances is calculated in the same manner by changing the rotation angle θ, so as to find a rotation angle θm where the sum Lm of the distances is the smallest (see FIG. 23). The above-described calculation is performed on the other candidate roads so as to obtain the sum of distances and the rotation angle. Then, a candidate road in which the sum of the distances is the smallest, that is, a candidate road having a maximum correlation, is obtained. Then, the candidate road is moved parallel so that the start point thereof overlaps with the start point of the track, and is rotated by the rotation angle θm so that the vehicle position is map-matched on the candidate road. Accordingly, the process ends. As can be understood by the above description, obtaining correlation is the basis of pattern matching.

The map matching process based on pattern matching involves a large amount of calculation. For this reason, the calculation is performed every time the vehicle runs 150 m or every several seconds, whereas map matching based on a projection method is performed when the vehicle runs 10 m or every 0.8 seconds. The map matching process based on the projection method is locally performed. Thus, a vehicle position is continuously corrected on a wrong road once matching is wrongly performed. In order to prevent such a problem, pattern matching is used in parallel.

FIG. 24 is an illustration of an initial operation of map matching. At an initial state, a position measured by a GPS is regarded as a vehicle position P, a square area SQAR having a predetermined size with the vehicle position P being at the center is set, roads that contact the ends of a perpendicular in the square area are set as candidate roads RDa and RDb, and the ends of the perpendicular are set as start points Qa and Qb of the candidate roads. Then, the position and azimuth of the vehicle are estimated by the SCN and equal-length vectorization is performed. After the vehicle has run a predetermined distance, a pattern matching process is performed so as to obtain the candidate road RDb having the largest correlation, and the estimated vehicle position P_{M} is corrected to an actual vehicle position Q_{M} on the road RDb. Thereafter, a map matching process based on pattern matching and projection is performed so as to correct the vehicle position onto the road RDb. If the pattern matching process becomes impossible to be performed, the above-described initial operation is performed.

As described above, in the known vehicle position estimating method, a vehicle position is estimated on the assumption that the vehicle travels straight in each unit time. In this method, an estimation error of a vehicle position is small when an actual road extends straight or substantially straight. Even if an estimation value deviates from the road, the degree of the deviation is small and thus the estimated vehicle position can be corrected onto the road by a map matching process. However, in the known method, a vehicle position is estimated on the assumption that the vehicle travels straight in each unit time even if the vehicle is traveling around a curve. Thus, as shown in FIG. 25A, an estimated vehicle position PTa gradually deviates from an actual road link PT. Accordingly, the degree of deviation gradually increases, and eventually it becomes impossible to correct the vehicle position onto the road link even if a map matching process is performed. FIG. 25B shows an ideal case where the vehicle position can be corrected onto the road link by a map matching process. In an actual case, however, correction cannot be done and a result shown in FIG. 25A is generated. When it becomes impossible to perform map matching, the map matching process is initialized and a position measured by the GPS is set as the vehicle position, as described above. Then, the position and azimuth of the vehicle are estimated by the SCN, the map matching process starts at the same time, and the estimated vehicle position is corrected to an actual vehicle position on the road. In this method, however, the vehicle position cannot immediately be corrected and thus a time period during which the vehicle position deviates from the road becomes long.

In order to estimate a vehicle position with high accuracy by the SCN, two different methods need to be prepared for traveling on a curve and traveling straight (first necessity). Also, the two methods need to be switched therebetween depending on whether the road is straight or curved (second necessity). However, such a vehicle position estimating method has not been proposed in the conventional SCN. In a method for measuring a track according to a first known art (see Japanese Unexamined Patent Application Publication No. 2004-226341), a track is measured with high accuracy by using absolute-position data obtained through GPS and relative-position data obtained through the SCN. However, in this method, a track with a small error is obtained on the basis of the shape of a straight part of the track obtained through the SCN and a traveling direction read from a track measured by the GPS, but the first and second necessities cannot be satisfied.

As a second known art (see Japanese Unexamined Patent Application Publication No. 9-145394), a curve detecting device to detect a large curve on a road has been proposed. However, the device according to the second known art detects a curve so that vehicle control suitable for an actual road condition and sense of a driver can be performed or that map data of a navigation system can be adequately used, and is not for estimating a vehicle position. (Also see Japanese Unexamined Patent Application Publication No. 2001-330445.)

### SUMMARY OF THE INVENTION

Accordingly, an object of the present invention is to estimate a vehicle position when the vehicle is traveling around a curve by using a method different from that used when the vehicle is traveling straight.

Another object of the present invention is to estimate a vehicle position with high accuracy by switching vehicle position estimating methods depending on whether the vehicle is traveling on a straight road or a curved road.

Another object of the present invention is to correct a measured road radius in accordance with a turning direction of the vehicle and estimate a vehicle position with high accuracy on a road link (center line of a road) by using the corrected radius.

Another object of the present invention is to perform navigation control by estimating and storing a first vehicle position on a center line of a road and a second vehicle position on an actual traveling line and by using the first and second estimated vehicle positions.

The above-described objects of the present invention are achieved by the following navigation system and vehicle position estimating method to detect a position of a vehicle and display a map of an area around the vehicle and a vehicle position mark on a display.

Vehicle Position Estimating Method According to a First Aspect

A vehicle position estimating method according to a first aspect of the present invention includes: providing a sensor to detect a velocity and an azimuth of a vehicle; calculating a turning radius of the vehicle by using a signal output from the sensor; and estimating a vehicle position on a road by using the turning radius. The turning radius is calculated by calculating an angular velocity of the vehicle and by using the angular velocity and a travel distance of each predetermined time period.

In the vehicle position estimating method according to the first aspect, the angular velocity of the vehicle is calculated every predetermined travel time period or every predetermined travel distance.

In the vehicle position estimating method according to the first aspect, a vehicle position is estimated by determining that the vehicle is traveling straight when the angular velocity is equal to or smaller than a set value, and a vehicle position is estimated by determining that the vehicle is traveling around a curve when the angular velocity is larger than the set value.

In the vehicle position estimating method according to the first aspect, a present vehicle position is estimated by calculating respective axial travel components along a straight or curved line of each predetermined time period and adding the respective axial travel components to respective axial components of a previous estimated position.

Vehicle Position Estimating Method According to a Second Aspect

A vehicle position estimating method according to a second aspect of the present invention includes: providing a sensor to detect a velocity and an azimuth of a vehicle; determining a turning direction of the vehicle on the basis of a change of the azimuth; calculating a turning radius R of the vehicle by using a signal output from the sensor; correcting the turning radius R so that the turning radius R becomes larger by a correction value WL according to a traveling position on a road if the vehicle turns to the left and correcting the turning radius R so that the turning radius R becomes smaller by a correction value WR according to a traveling position on a road if the vehicle turns to the right; and estimating a vehicle position on a center line of the road by using the corrected turning radius. The turning radius is calculated by calculating an angular velocity of the vehicle and by using the angular velocity and a travel distance of each predetermined time period.

In the vehicle position estimating method according to the second aspect, each of the correction values WR and WL is set to W/4 when a width of the road is W.

In the vehicle position estimating method according to the second aspect, a camera to capture an image of a road is provided on the vehicle, and the correction values WR and WL are obtained by measuring a distance from a center line of the road to a vehicle traveling position.

In the vehicle position estimating method according to the second aspect, the angular velocity of the vehicle is calculated every predetermined travel time period or every predetermined travel distance.

In the vehicle position estimating method according to the second aspect, a vehicle position is estimated by determining that the vehicle is traveling straight when the angular velocity is equal to or smaller than a set value, and a vehicle position is estimated by determining that the vehicle is traveling around a curve when the angular velocity is larger than the set value.

In the vehicle position estimating method according to the second aspect, a present vehicle position is estimated by calculating respective axial travel components along a straight or curved line of each predetermined time period and adding the respective axial travel components to respective axial components of a previous estimated position.

Vehicle Position Estimating Method According to a Third Aspect

A vehicle position estimating method according to a third aspect of the present invention includes: providing a sensor to detect a velocity and an azimuth of a vehicle; estimating a first vehicle position on an actual traveling line of a road and a second vehicle position on a center line of the road by using a signal output from the sensor and storing the first and second vehicle positions; and performing navigation control by using the first and second vehicle positions.

In the vehicle position estimating method according to the third aspect, the first vehicle position is corrected on the basis of a GPS position and the second vehicle position is corrected on the basis of a map matching process.

In the vehicle position estimating method according to the third aspect, a sensor to detect a velocity and an azimuth of a vehicle is provided, an angular velocity of the vehicle is calculated by using a signal output from the sensor, a turning radius R of the vehicle is calculated by using the angular velocity and a travel distance of the vehicle of each predetermined time period and the first vehicle position is estimated on the traveling line of the road by using the turning radius R, the turning radius R is corrected so that the turning radius R becomes larger by a correction value WL according to a traveling position on the road if the vehicle turns to the left and the turning radius R is corrected so that the turning radius R becomes smaller by a correction value WR according to a traveling position on the road if the vehicle turns to the right, and the second vehicle position is estimated on the center line of the road by using the corrected turning radius.

Navigation System According to a Fourth Aspect

A navigation system according to a fourth aspect of the present invention includes: a sensor to detect a velocity and an azimuth of a vehicle; an angular velocity calculating unit to calculate an angular velocity of the vehicle by using a signal output from the sensor; a turning radius calculating unit to calculate a turning radius of the vehicle by using the angular velocity and a travel distance of each predetermined time period; and a vehicle position estimating unit to estimate a vehicle position on a road by using the turning radius. The vehicle position estimating unit estimates a vehicle position by determining that the vehicle is traveling straight when the angular velocity is equal to or smaller than a set value and estimates a vehicle position by determining that the vehicle is traveling around a curve when the angular velocity is larger than the set value.

Navigation System According to a Fifth Aspect

A navigation system according to a fifth aspect of the present invention includes: a sensor to detect a velocity and an azimuth of a vehicle; a turning direction determining unit to determine a turning direction of the vehicle on the basis of a change of the azimuth; an angular velocity calculating unit to calculate an angular velocity of the vehicle by using a signal output from the sensor; a turning radius calculating unit to calculate a turning radius R of the vehicle by using the angular velocity and a travel distance of each predetermined time period; a turning radius correcting unit to correct the turning radius R so that the turning radius R becomes larger by a correction value WL according to a traveling position on a road if the vehicle turns to the left and correct the turning radius R so that the turning radius R becomes smaller by a correction value WR according to a traveling position on a road if the vehicle turns to the right; and a vehicle position estimating unit to estimate a vehicle position on a center line of the road by using the corrected turning radius. The vehicle position estimating unit estimates a vehicle position by determining that the vehicle is traveling straight when the angular velocity is equal to or smaller than a set value and estimates a vehicle position by determining that the vehicle is traveling around a curve when the angular velocity is larger than the set value.

Navigation System According to a Sixth Aspect

A navigation system according to a sixth aspect of the present invention includes: a sensor to detect a velocity and an azimuth of a vehicle; a vehicle position estimating unit to estimate a first vehicle position on an actual traveling line of a road and a second vehicle position on a center line of the road by using a signal output from the sensor and store the first and second vehicle positions; and a navigation control unit to perform navigation control by using the first and second vehicle positions on the basis of a process.

The navigation system according to the sixth aspect further includes: a GPS position measuring unit to measure a GPS position on the basis of a GPS signal from a satellite; a GPS position correcting unit to correct the first vehicle position on the basis of the GPS position; and a map matching process unit to correct the second vehicle position.

The navigation system according to the sixth aspect further includes: a sensor to detect a velocity and an azimuth of a vehicle; and an angular velocity calculating unit to calculate an angular velocity of the vehicle by using a signal output from the sensor. The vehicle position estimating unit includes: a first position estimating unit to calculate a turning radius R of the vehicle by using the angular velocity and a travel distance of the vehicle of each predetermined time period and estimate the first vehicle position on the traveling line of the road by using the turning radius R; and a second position estimating unit to correct the turning radius R so that the turning radius R becomes larger by a correction value WL according to a traveling position on the road if the vehicle turns to the left and correct the turning radius R so that the turning radius R becomes smaller by a correction value WR according to a traveling position on the road if the vehicle turns to the right, and estimate the second vehicle position on the center line of the road by using the corrected turning radius.

According to the present invention, a sensor to detect a velocity and an azimuth of a vehicle is provided, a turning radius of the vehicle is calculated by using a signal output from the sensor, and a vehicle position is estimated on a road by using the turning radius. Accordingly, a vehicle position can be estimated more accurately when the vehicle is traveling around a curve by using a method different from that used when the vehicle is traveling straight.

According to the present invention, a vehicle position is estimated by determining that the vehicle is traveling straight when the angular velocity is equal to or smaller than a set value and by determining that the vehicle is traveling around a curve when the angular velocity is larger than the set value. Accordingly, a vehicle position can be estimated more accurately regardless of whether the vehicle is traveling on a straight road or a curved road.

According to the present invention, a turning direction of the vehicle is determined on the basis of a change in the azimuth of the vehicle. If the vehicle turns to the left, the turning radius is corrected by adding a correction value WL to the turning radius. If the vehicle turns to the right, the turning radius is corrected by subtracting a correction value WR from the turning radius. By using the corrected turning radius, a vehicle position is estimated on a center line of the road. Accordingly, the vehicle position can be estimated more accurately and a vehicle position mark can be displayed on a road link of a map.

According to the present invention, a first vehicle position on a center line of a road is estimated by using a signal output from an SCN sensor, a second vehicle position on an actual traveling line of the road is estimated, and the first and second vehicle positions are stored. Navigation control is performed by using the first and second vehicle positions. Accordingly, appropriate navigation control can be performed by using the first and second vehicle positions. For example, a map matching process, display of a vehicle position mark, calculation of a distance along a road, and route guiding can be performed by using the first vehicle position. Correction of a position by GPS, display of a vehicle position mark on a town map, and estimation of a traveling lane can be performed by using the second vehicle position.

### BRIEF DESCRIPTION OF THE DRAWINGS

FIGS. 1A and 1B are illustrations of a vehicle position estimating method used when a vehicle is traveling around a curve;

FIG. 2 shows a vehicle position estimating unit based on SCN according to a first embodiment of the present invention;

FIG. 3 shows a configuration of a navigation system including the vehicle position estimating unit;

FIG. 4 is a flowchart showing a vehicle position estimating process performed by the vehicle position estimating unit;

FIG. 5 is an illustration of a result of the estimation of a vehicle position according to the first embodiment;

FIG. 6 is an illustration of a state where a track B deviates from a road link A in a solid line;

FIG. 7 is an illustration of the operation of a second embodiment;

FIGS. 8A and 8B are illustrations of a principle of a vehicle position estimating method according to the second embodiment;

FIG. 9 shows a configuration of a vehicle position estimating unit based on SCN according to the second embodiment;

FIGS. 10A and 10B are illustrations of a method for setting a correction value of a turning radius;

FIG. 11 is a flowchart showing a vehicle position estimating process performed by the vehicle position estimating unit according to the second embodiment;

FIG. 12 is an illustration of a winding road link A extending to the top of a mountain;

FIG. 13 is an illustration of a track B generated by a map matching process using a vehicle estimation value according to the first embodiment;

FIG. 14 is an illustration of a track generated by a map matching process using a vehicle estimation value according to the second embodiment;

FIG. 15 shows a modification of the vehicle position estimating unit according to the second embodiment;

FIG. 16 is a block diagram showing a navigation system according to a third embodiment;

FIGS. 17A and 17B are flowcharts showing vehicle position estimating processes performed by an actual present position estimating/storing unit and an on-link present position estimating/storing unit, respectively;

FIG. 18 is an illustration of a known vehicle position estimating method based on SCN;

FIG. 19 is an illustration of map matching based on a projection method;

FIG. 20 is another illustration of map matching based on the projection method;

FIGS. 21A and 21B are first illustrations of map matching based on pattern matching;

FIG. 22 is a second illustration of map matching based on pattern matching;

FIG. 23 is a third illustration of map matching based on pattern matching;

FIG. 24 is an illustration of an initial operation of map matching; and

FIGS. 25A and 25B are illustrations of a problem caused in the known vehicle position estimating method based on SCN.

### DESCRIPTION OF THE PREFERRED EMBODIMENTS

In a navigation system to detect a position of a vehicle and to display a map of an area around the vehicle and a vehicle position mark on a display, a self-contained navigation (SCN) sensor detects the velocity and azimuth of the vehicle, a vehicle turning direction calculating unit determines a turning direction of the vehicle on the basis of a change in azimuth of the vehicle, an angular velocity calculating unit calculates an angular velocity of the vehicle by using a signal output from the SCN sensor, a turning radius calculating unit calculates a turning radius R of the vehicle by using the angular velocity and a travel distance of the vehicle in each predetermined time period, a turning radius correcting unit corrects the turning radius R so that the turning radius R becomes larger by a correction value WL according to a traveling position on a road if the vehicle turns to the left or that the turning radius R becomes smaller by a correction value WR according to a traveling position on a road if the vehicle turns to the right, and a vehicle position estimating unit estimates a vehicle position on the center of the road by using the corrected turning radius. A correction value setting unit sets the correction values WR and WL to W/4 when the width of the road is W. Alternatively, an image of the road is captured by a camera, a distance from the center of the road to a vehicle traveling position is measured by image processing, and WR and WL are set. If the angular velocity is equal to or smaller than a set value, the vehicle position estimating unit determines that the vehicle is traveling straight and estimates a vehicle position on a straight link. If the angular velocity is larger than the set value, the vehicle position estimating unit determines that the vehicle is traveling around a curve and estimates a vehicle position on a curved link. At this time, respective axial travel components along the straight or curved line of each predetermined time period are calculated, the respective axial travel components are added to respective axial components of a previous estimated position, so that a present position is estimated.

### First Embodiment

(a) Principle of Estimation of a Vehicle Position

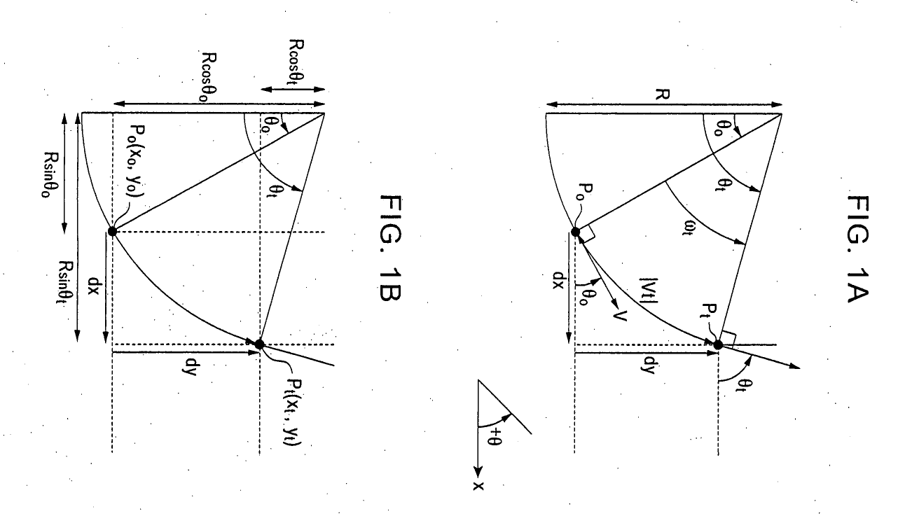

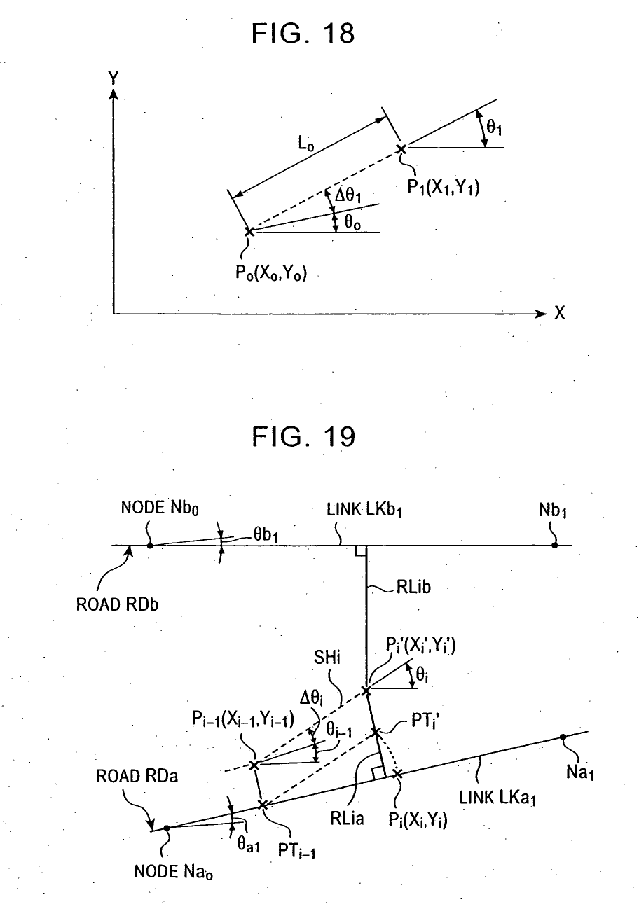

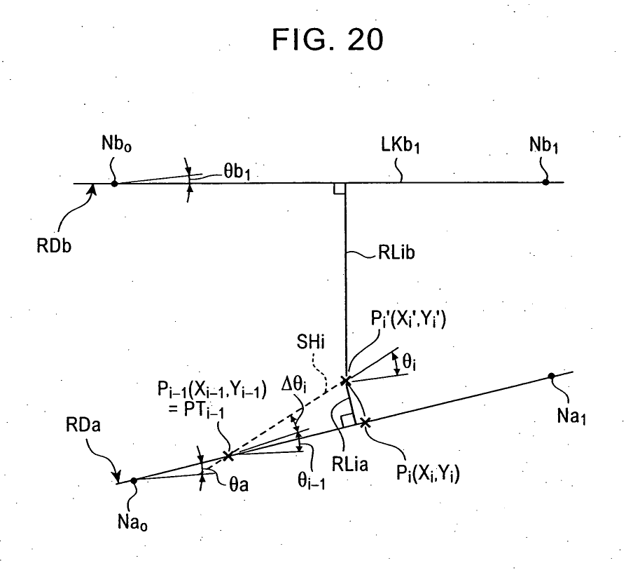

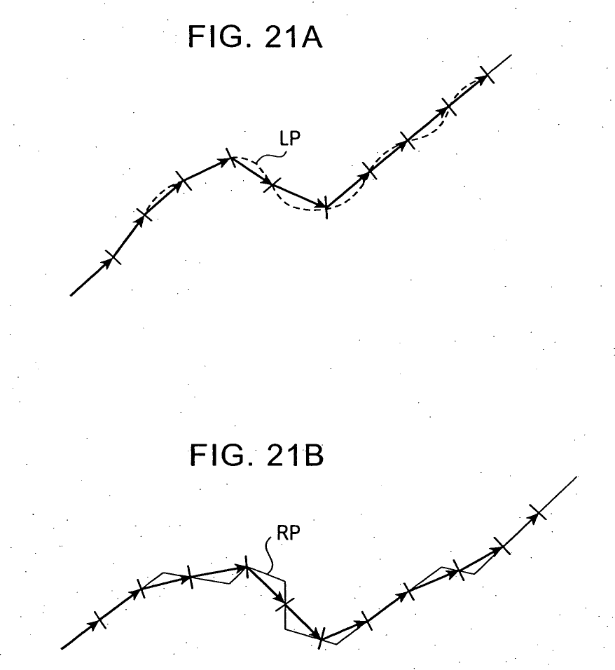

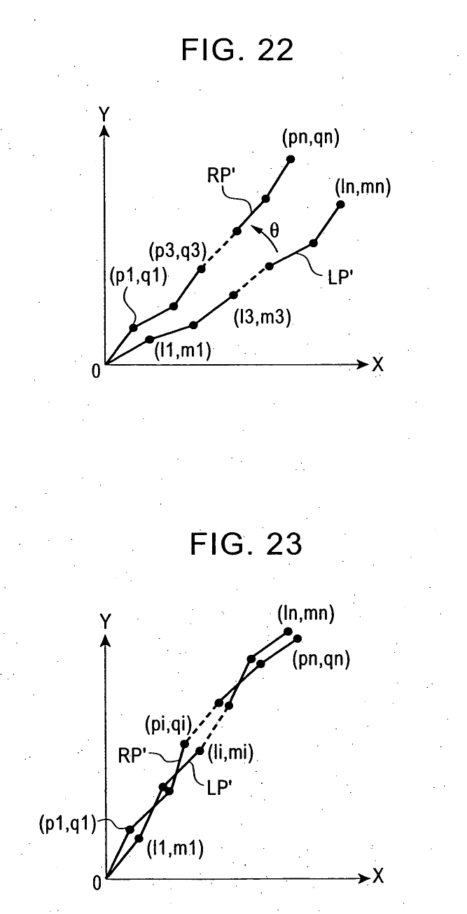

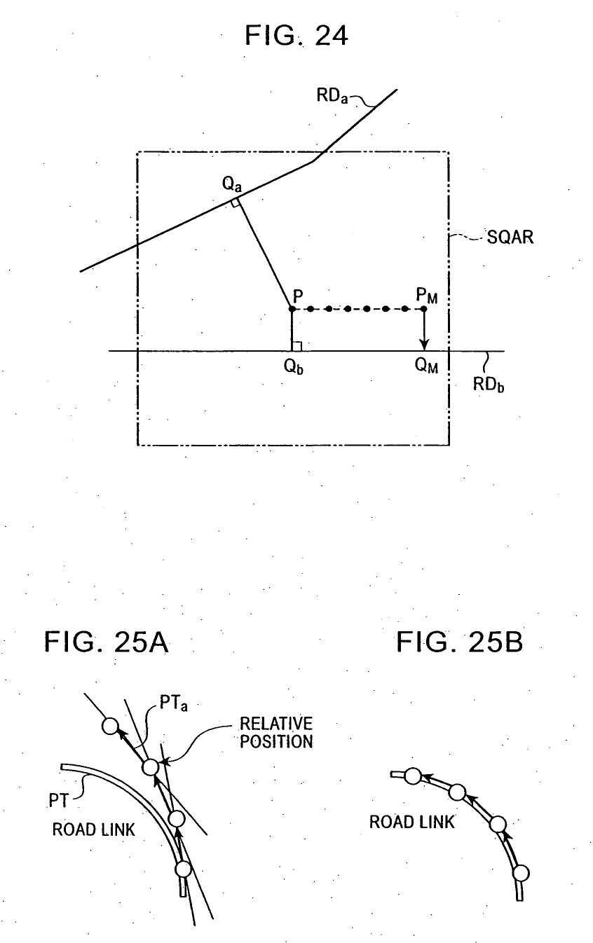

When a vehicle is traveling straight, a vehicle position is estimated on a straight road link by using the known method (see FIG. 18). However, when the vehicle is traveling around a curve, a turning radius R of the vehicle is calculated and a vehicle position is estimated on a curved road link having the radius R. FIGS. 1A and 1B are illustrations of a vehicle position estimating method used when the vehicle is traveling around a curve. The symbols shown in the figures represent the following:

R: turning radius of vehicle [m];

V: travel velocity of vehicle [m/sec];

ω: angular velocity of vehicle [radians/sec];

P₀ (x₀, y₀): present position of vehicle;

θ₀: present traveling direction of vehicle;

Pt (xt, yt): vehicle position after t seconds; and

θt (xt, yt): traveling direction of vehicle after t seconds.

Referring to FIG. 1A, the turning radius R of the vehicle when the vehicle travels around a curve at the velocity V from the start point P₀ (x₀, y₀) and reaches the point Pt (xt, yt) after time t can be calculated by using the following expression:
R=|V·t|/ω·t==|V|/ω (5).

Therefore, referring to FIG. 1B, increments dx and dy in the X-axis and Y-axis directions can be expressed by the following expressions:

$$\begin{matrix}dx = R sin θ t - R sin {θ}_{0} \\ = R ( sin ( {θ}_{0} + ω t ) - sin {θ}_{0} ) ; and \\ dy = R cos {θ}_{0} - R cos θ t \\ = R ( cos {θ}_{0} - cos ( {θ}_{0} + ω t ) ) .\end{matrix}$$

The vehicle position after t seconds Pt (xt, yt) can be calculated by using the following expressions:
xt=x₀+(R sin θt−R sin θ₀) (6); and
yt=y₀+(R cos θ₀−R cos θt) (7).

If the absolute value of the angular velocity ω is equal to or smaller than a set value, e.g., 0.01 radians, it is determined that the vehicle is traveling straight. If the absolute value of the angular velocity ω is larger than the set value, it is determined that the vehicle is traveling around a curve. When the vehicle is traveling straight, the vehicle position after t seconds Pt (xt, yt) is calculated by using the following expressions:
xt=x₀+V cos θt (8); and
yt=y₀+V sin θt (9).
(b) Vehicle Position Estimating Unit

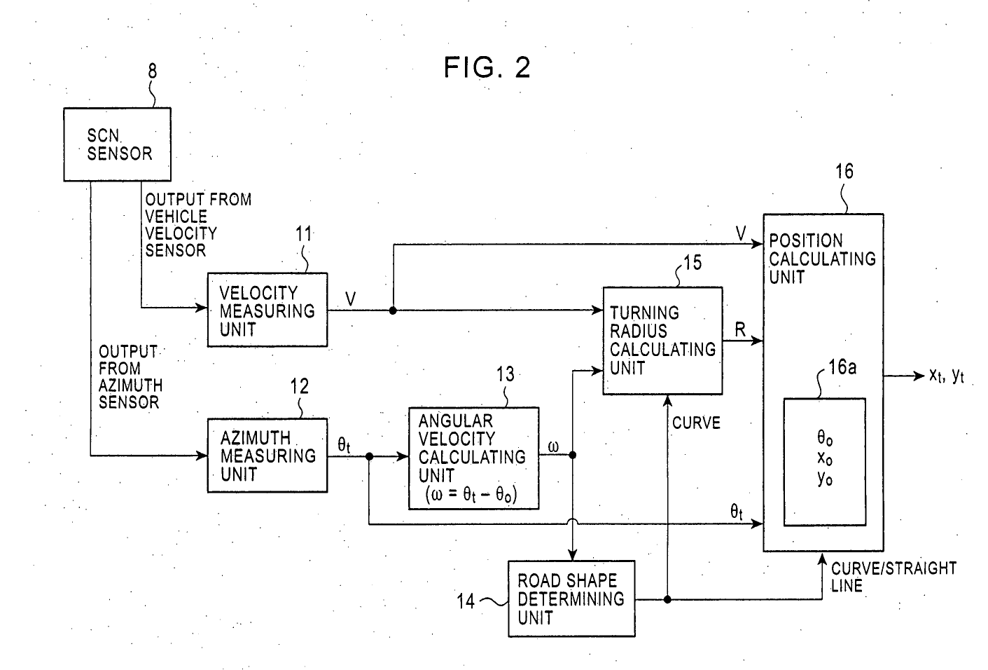

FIG. 2 shows a vehicle position estimating unit based on the SCN according to the first embodiment of the present invention. A velocity measuring unit 11 measures a travel velocity V of the vehicle by using a signal output from a vehicle velocity sensor (distance sensor) of an SCN sensor 8 and inputs the velocity V to a turning radius calculating unit 15 and a position calculating unit 16. An azimuth measuring unit 12 measures an azimuth (traveling direction) of the vehicle by using a signal output from an azimuth sensor of the SCN sensor 8 and inputs the azimuth to an angular velocity calculating unit 13 and the position calculating unit 16. The angular velocity calculating unit 13 calculates an angular velocity ω (=θt−θ0) by using a difference between the azimuths θ₀ and θt of the present vehicle position P₀ and the vehicle position after t seconds Pt and inputs the angular velocity ω to a road shape determining unit 14 and the turning radius calculating unit 15. The road shape determining unit 14 determines that the road is curved if the angular velocity ω is larger than a set value and that the road is straight if the angular velocity ω is equal to or smaller than the set value. Also, the road shape determining unit 14 inputs the determination result to the turning radius calculating unit 15 and the position calculating unit 16. If the road is curved, the turning radius calculating unit 15 calculates the turning radius R on the basis of expression (5) and inputs the turning radius R to the position calculating unit 16. The position calculating unit 16 includes a memory 16a storing the respective axial coordinates x₀ and y₀ and the azimuth θ₀ of the latest estimated vehicle position P₀. If the vehicle is traveling straight, the position calculating unit 16 calculates the respective axial position coordinates xt and yt at the vehicle position Pt on the basis of expressions (8) and (9) by using the values stored in the memory 16a and the input vehicle travel velocity V, turning radius R, and azimuth θt at the vehicle position Pt. If the vehicle is traveling around a curve, the position calculating unit 16 calculates the respective axial position coordinates xt and yt at the vehicle position Pt on the basis of expressions (6) and (7). Then, the position calculating unit 16 outputs xt and yt and continues the above-described position estimating operation by setting the xt, yt, and θt as x₀, y₀, and θ₀.

(c) Navigation System

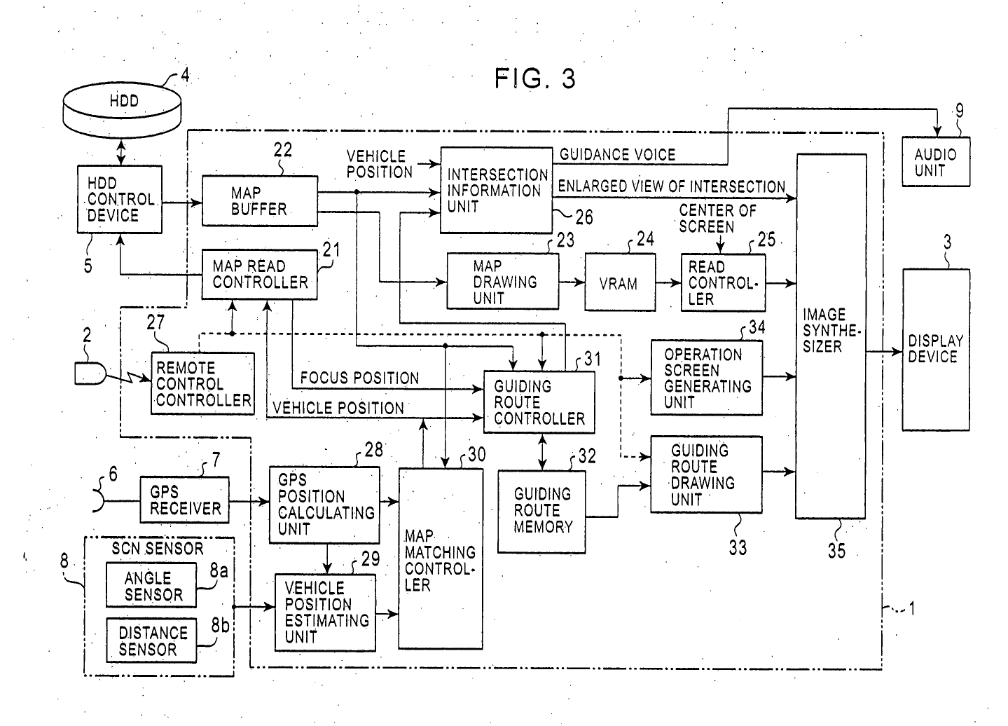

FIG. 3 shows a configuration of a navigation system including the above-described vehicle position estimating unit.

The navigation system includes a navigation control device 1, a remote control 2, a display device (color monitor) 3, a hard disk drive (HDD) 4, an HDD control device 5, a multi-beam antenna 6, a GPS receiver 7, the SCN sensor 8, and an audio unit 9. The HDD 4 stores map data. The SCN sensor 8 includes a relative azimuth sensor (angle sensor) 8a, such as a vibrating gyroscope to detect a turning angle of the vehicle, and a distance sensor 8b to generate a pulse for every predetermined travel distance.

In the navigation control device 1, a map read controller 21 reads predetermined map information from the HDD 4 by controlling the HDD control device 5 on the basis of a vehicle position. A map buffer 22 stores the map information read from the HDD 4. More specifically, the map buffer 22 stores a plurality of units of map information about an area around the vehicle, e.g., 3×3 units of map information, so that the map can be scrolled.

A map drawing unit 23 generates a map image by using the map information stored in the map buffer 22. A VRAM 24 stores the map image. A read controller 25 changes the range of an image to be extracted from the VRAM 24 on the basis of the center of the screen (the position of the vehicle) and scrolls the map in accordance with the travel of the vehicle.

An intersection information unit 26 displays an enlarged view of an approaching intersection and guides a traveling direction at the intersection through an image and voice. That is, during actual route guiding, when the vehicle is within a predetermined distance from an intersection, the intersection information unit 26 displays the intersection information (enlarged view of the intersection and an arrow indicating a traveling direction) on the display and also guides the traveling direction by voice. A remote control controller 27 receives signals in accordance with an operation made on the remote control 2 and provides instructions to each unit.

A GPS position calculating unit 28 calculates a present position (GPS position) and azimuth of the vehicle on the basis of GPS data input from the GPS receiver 7. The vehicle position estimating unit 29 based on the SCN has the configuration shown in FIG. 2 and calculates the position and azimuth of the vehicle by the SCN by using the GPS position as an initial position. That is, the vehicle position estimating unit 29 estimates the position and azimuth of the vehicle on the basis of output from the SCN sensor 8 and stores a track: relative distance and azimuth in the X and Y directions of each predetermined time period.

A map matching controller 30 performs a map matching process by using the map information read to the map buffer 22, estimated vehicle position, azimuth of the vehicle, and track, so as to correct the vehicle position onto the road on which the vehicle is actually traveling. The map matching process is performed by using pattern matching and projection in parallel. The pattern matching is performed every time the vehicle runs 150 m, and map matching based on projection is performed every 0.8 seconds.

A guiding route controller 31 calculates a guiding route (searched route) from an input start point to a destination. A guiding route memory 32 stores the guiding route. A guiding route drawing unit 33 reads guiding route information (node sequence) from the guiding route memory 32 and draws a guiding route during travel. An operation screen generating unit 34 generates various menu screens (operation screens). An image synthesizer 35 synthesizes various images and outputs the generated image.

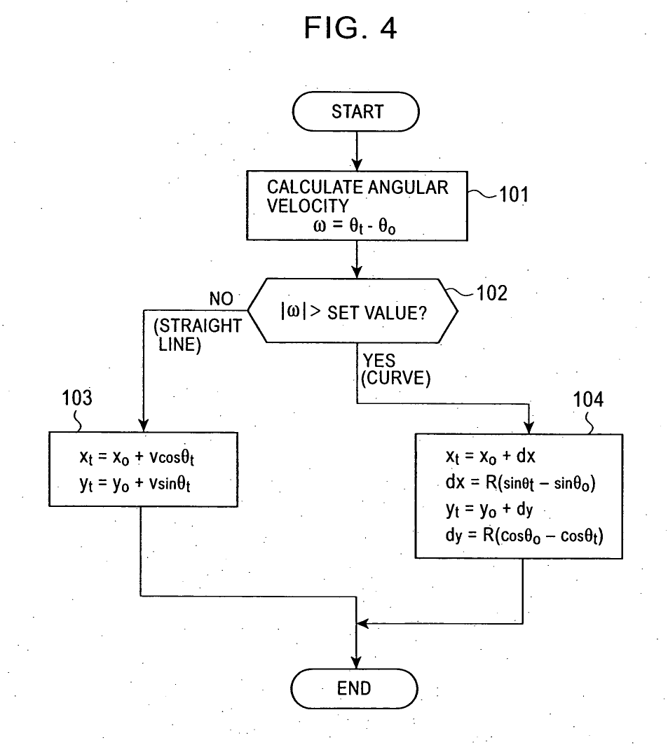

FIG. 4 is a flowchart showing a vehicle position estimating process performed by the vehicle position estimating unit 29. The vehicle position estimating unit 29 calculates an angular velocity ω in step 101, and compares the angular velocity |ω| with a set value in step 102. If |ω| is equal to or smaller than the set value, the vehicle position estimating unit 29 determines that the vehicle is traveling straight and calculates the respective axial position coordinates xt and yt at the vehicle position Pt on the basis of expressions (8) and (9) in step 103. If |ω| is larger than the set value, the vehicle position estimating unit 29 determines that the vehicle is traveling around a curve and calculates the respective axial position coordinates xt and yt at the vehicle position Pt on the basis of expressions (6) and (7) in step 104. Then, the vehicle position estimating unit 29 repeats the above-described process every predetermined time period so as to estimate the vehicle position.

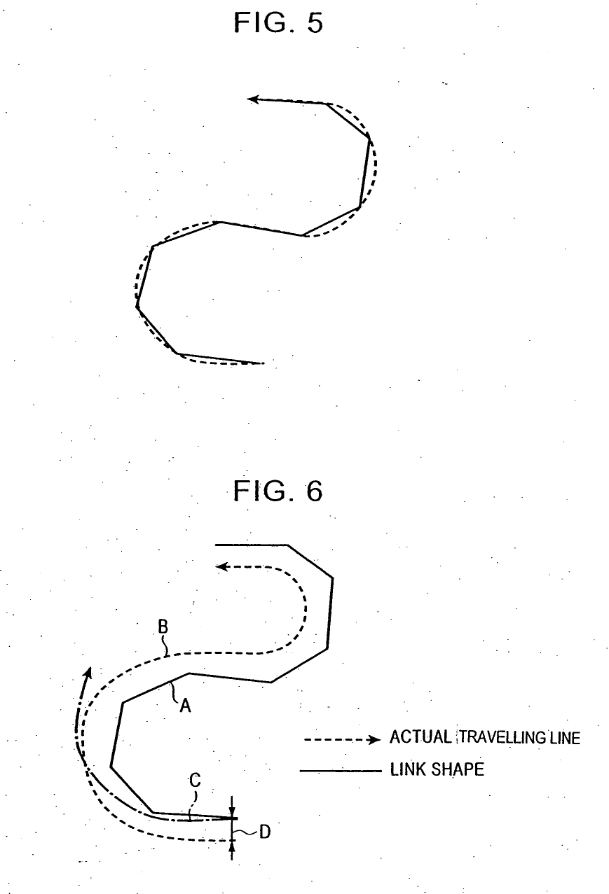

FIG. 5 is an illustration of a result of vehicle position estimation according to the first embodiment. In the figure, a solid line indicates the shape of a road and a broken line indicates an actual track of the vehicle estimated in the first embodiment. As can be seen in the figure, the vehicle position can be accurately estimated even though the road is curved.

In the above-described embodiment, the turning radius R of the vehicle is calculated based on expression (5) by using ω and V. Alternatively, the turning radius R can be calculated by substituting three previous position data xi and yi of the vehicle into the following expression:

(x−xc)²+(y−yc)²=R². Herein, (xc, yc) are central coordinates of a circle.

According to the first embodiment, a vehicle position can be accurately estimated when the vehicle is traveling around a curve by using a method different from a method that is used when the vehicle is traveling straight.

According to the first embodiment, if the angular velocity is equal to or smaller than the set value, it is determined that the vehicle is traveling straight and a vehicle position is estimated. On the other hand, if the angular velocity is larger than the set value, it is determined that the vehicle is traveling around a curve and a vehicle position is estimated. Accordingly, a vehicle position can be accurately estimated regardless of whether the vehicle is traveling on a straight road or a curved road.

### Second Embodiment

A road link included in the map data is generated based on a center line of the road, and thus the road link on the map indicates the center line of the road. On the other hand, the estimated vehicle position in the first embodiment is a position on a line on which the vehicle actually travels. Thus, if the traveling line matches the center line of the road, the position on the center line of the road can be estimated even if the road is curved as shown in FIG. 5, and a vehicle position mark can be displayed on the road link in a drawn map. However, in Japan, for example, the vehicle does not actually travel on the center line but travels on a left side of the center line by a predetermined distance D. In other words, an actual turning radius of the vehicle is different than the radius of the road link. Therefore, a distance error occurs in the forward and backward directions on a curve and an estimated vehicle position deviates from the road link. FIG. 6 illustrates a situation in which a track B deviates from a road link A indicated by a solid line. As indicated by a broken line, the track B deviates from the road link A by a predetermined distance D, and a vehicle position mark is not displayed on the road link. Furthermore, even if the vehicle position is corrected onto the road link A by a map matching process, as indicated by a line C, position errors accumulate and eventually it may become impossible to perform the map matching process.

(a) Outline of the Second Embodiment

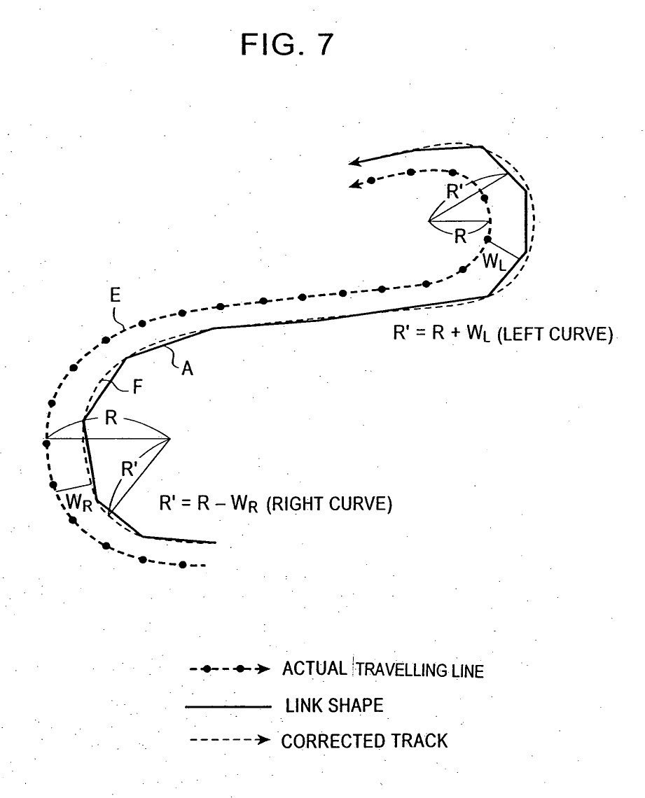

FIG. 7 illustrates an outline of the second embodiment. In the figure, A denotes a center line of a road (road link), E denotes an actual traveling line, and F denotes a corrected traveling line based on a vehicle position estimated in the second embodiment. When the vehicle is traveling around a curve, if the vehicle turns to the right, a correction value WR according to a position on the road is subtracted from the turning radius R of the vehicle so that the turning radius R is corrected to a turning radius R′ (=R−WR). If the vehicle turns to the left, a correction value WL according to a position on the road is added to the turning radius R so that the turning radius R is corrected to a turning radius R′ (=R+WL). By using the corrected turning radius R′, the vehicle position is estimated on the center line of the road. Note that, the above-described method is applied in Japan, where vehicles drive on the left. If this method is applied in a country where vehicles drive on the right, the turning radius is corrected in an opposite manner. That is, when the vehicle is traveling around a curve, if the vehicle turns to the left, a correction value WL according to a position on the road is subtracted from the turning radius R and so that the turning radius R is corrected to a turning radius R′ (=R−WL). If the vehicle turns to the right, a correction value WR according to a position on the road is added to the turning radius R so that the turning radius R is corrected to a turning radius R′ (=R+WR). By using the corrected turning radius R′, the vehicle position is estimated on the center line of the road.

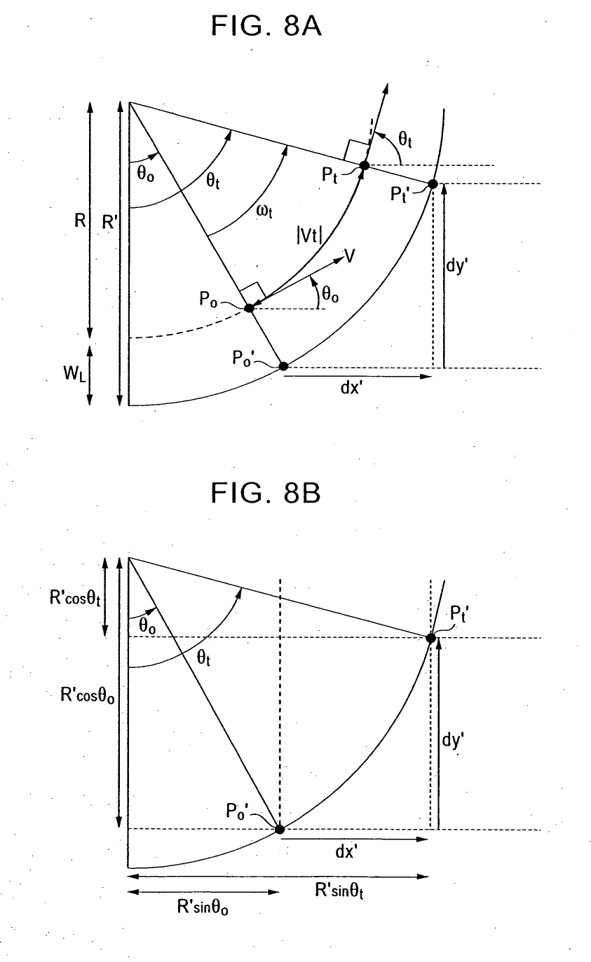

FIGS. 8A and 8B are illustrations of a principle of a vehicle position estimating method according to the second embodiment. The symbols in the figures represent the following:

R: turning radius of vehicle [m];

V: travel velocity of vehicle [m/sec];

ω: angular velocity of vehicle [radians/sec];

P₀ (x₀, y₀): present position of vehicle;

θ₀: present traveling direction of vehicle;

Pt (xt, yt): vehicle position after t seconds;

θt: traveling direction of vehicle after t seconds;

P₀′ (x₀′, y₀′): position on a center line of a road according to the present position of the vehicle;

Pt′ (xt′, yt′): position on a center line of a road according to the position of the vehicle after t seconds;

R′: corrected turning radius (curvature radius of road link);

WR: distance between traveling line and link (at right curve) [m]; and

WL: distance between traveling line and link (at left curve) [m].

Referring to FIG. 8A, the turning radius R of the vehicle when the vehicle travels around a curve at the velocity V from the start point P₀ (x₀, y₀) and reaches the point Pt (xt, yt) after time t can be calculated by using expression (5):
R=|V·|/ω·t=|V|/ω.

At a left curve, the curvature radius R′ of the road link can be expressed by the following expression:
R′=R+WL (at a left curve: ω>0, R>0, R′>0) (10).

At a right curve, the curvature radius R′ of the road link can be expressed by the following expression:
R′=R+WR (at a right curve: ω<0, R<0, R′<0) (11).

Accordingly, referring to FIG. 8B, increments dx′ and dy′ in the X-axis and Y-axis directions along the road link can be expressed by the following expressions:

$$\begin{matrix}{dx}^{′} = {R}^{′} sin θ t - {R}^{′} sin {θ}_{0} \\ = {R}^{′} ( sin ( {θ}_{0} + ω t ) - sin {θ}_{0} ) ; and \\ {dy}^{′} = {R}^{′} cos {θ}_{0} - {R}^{′} cos θ t \\ = {R}^{′} ( cos {θ}_{0} - cos ( {θ}_{0} + ω t ) ) . \end{matrix}$$

The vehicle position after t seconds Pt′ (xt′, yt′) can be calculated by using the following expressions:
xt′=x₀′+(R′ sin θi−R′ sin θ₀) (12); and
yt′=y₀′+(R′ cos θ₀−R′ cos θt) (13).
Herein,
x₀′=x₀+WL×sin θ₀ (14); and
y₀′=y₀−WL×cos θ₀ (15).

As in the first embodiment, if the absolute value of the angular velocity ω is equal to or smaller than a set value, e.g., 0.01 radians, it is determined that the vehicle is traveling straight. If the absolute value of the angular velocity ω is larger than the set value, it is determined that the vehicle is traveling around a curve. When the vehicle is traveling straight, the vehicle position after t seconds Pt (xt, yt) is calculated by using expressions (8) and (9) (shown again):
xt=x0+V cos θt (8); and
yt=y₀+V sin θt (9).

Then, the vehicle position Pt (xt, yt) is shifted by WL to the right side in the traveling direction and so as to calculate the vehicle position Pt′ (xt′, yt′) on the road link. In the above description, R and R′include a sign. Therefore, R′=R+WR is satisfied at a right curve.

(b) Vehicle Position Estimating Unit According to the Second Embodiment

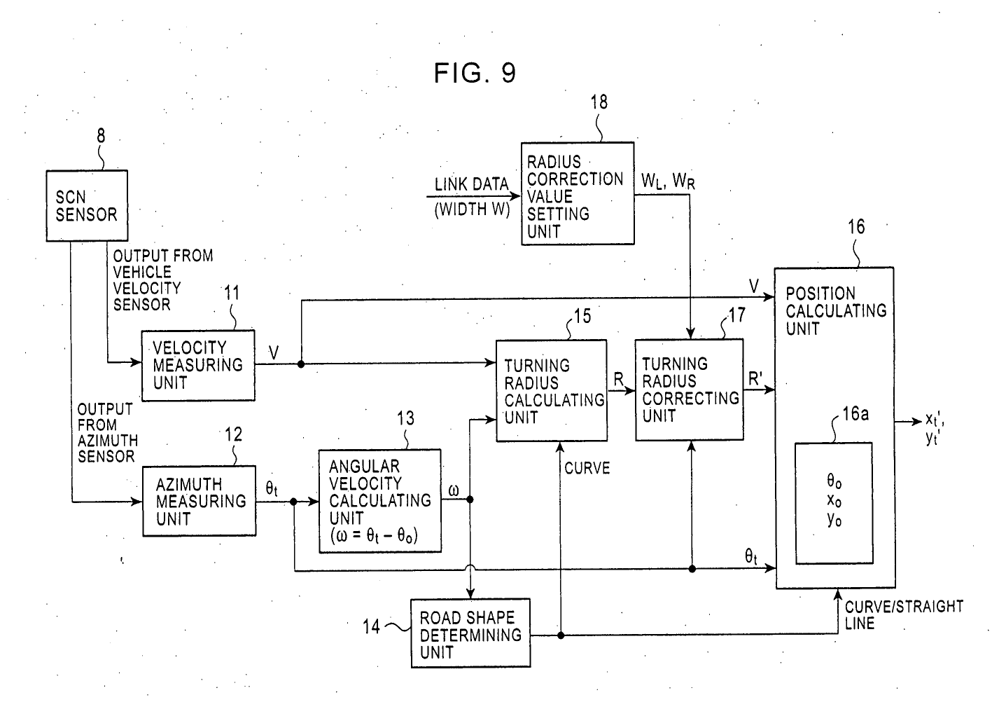

FIG. 9 shows a configuration of a vehicle position estimating unit based on the SCN according to the second embodiment. In FIG. 9, the parts that are the same as those of the vehicle position estimating unit according to the first embodiment shown in FIG. 2 are denoted by the same reference numerals.

A velocity measuring unit 11 measures a travel velocity V of the vehicle by using a signal output from a vehicle velocity sensor (distance sensor) of the SCN sensor 8 and inputs the velocity V to a turning radius calculating unit 15 and a position calculating unit 16. An azimuth measuring unit 12 measures an azimuth (traveling direction) θt of the vehicle by using a signal output from an azimuth sensor of the SCN sensor 8 and inputs the azimuth θt to an angular velocity calculating unit 13, the position calculating unit 16, and a turning radius correcting unit 17. The angular velocity calculating unit 13 calculates an angular velocity ω (=θt−θ₀) by using a difference between the azimuths θ₀ and θt of the present vehicle position P₀ and the vehicle position after t seconds Pt and inputs the angular velocity ω to a road shape determining unit 14 and the turning radius calculating unit 15. The road shape determining unit 14 determines that the road is curved if the angular velocity ω is larger than a set value and that the road is straight if the angular velocity ω is equal to or smaller than the set value. Also, the road shape determining unit 14 inputs the determination result to the turning radius calculating unit 15 and the position calculating unit 16. If the road is curved, the turning radius calculating unit 15 calculates the turning radius R on the basis of expression (5) and inputs the turning radius R to the turning radius correcting unit 17.

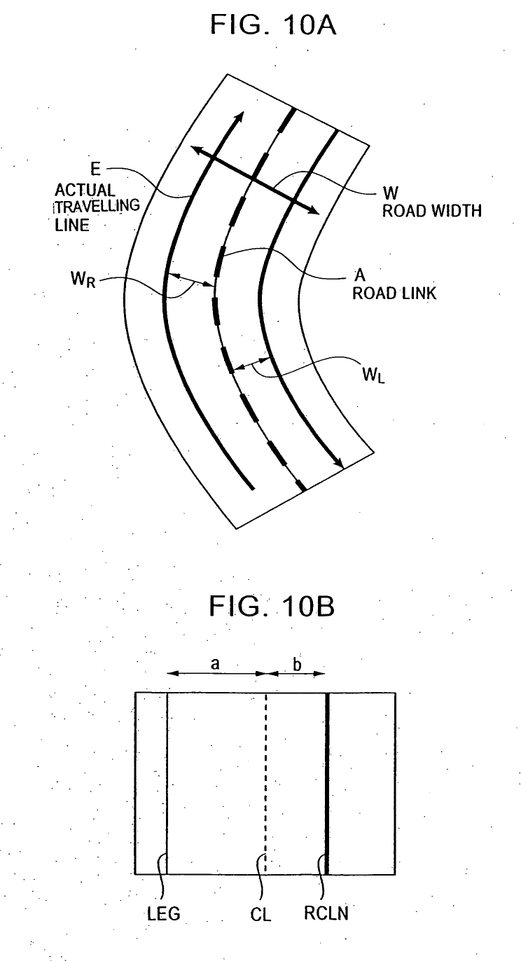

A radius correction value setting unit 18 extracts a width W of a road on which the vehicle is presently traveling from link data included in the map data, and outputs ¼ of the width W as WL and WR (WL=WR=W/4). This is because, as shown in FIG. 10A, a vehicle typically travels at the center of a lane and thus a traveling line E is at a position spaced from a center line (road link) A by W/4. The turning radius correcting unit 17 determines the sign of a difference θt−θ₀ between the azimuth θ₀ at the present position P₀ and the azimuth θt at the vehicle position Pt after t seconds, and determines the turning direction on the basis of the sign. For example, θt−θ₀>0 means a left curve, whereas θt−θ₀<0 means a right curve. Then, the turning radius correcting unit 17 calculates the curvature radius R′ of the road link when the vehicle is traveling around a left curve by using expression (10):
R′=R+WL.

When the vehicle is traveling around a right curve, the turning radius correcting unit 17 calculates the curvature radius R′ of the road link by using expression (11):
R′=R+WR.

The position calculating unit 16 includes a memory 16a storing the respective axial coordinates x₀ and y₀ and the azimuth θ₀ of the latest estimated vehicle position P₀. If the vehicle is traveling straight, the position calculating unit 16 calculates the respective axial position coordinates xt and yt at the vehicle position Pt on the basis of expressions (8) and (9) by using the values stored in the memory 16a and the input vehicle travel velocity V, turning radius R′, and azimuth θt at the vehicle position Pt, and shifts the vehicle position Pt (xt, yt) by WL to the right side in the traveling direction so as to calculate the vehicle position Pt′ (xt′, yt′) on the road link. On the other hand, if the vehicle is traveling around a curve, the position calculating unit 16 calculates the respective axial position coordinates xt′ and yt′ at the vehicle position Pt′ on the basis of expressions (12) and (13). Then, the position calculating unit 16 outputs the xt′ and yt′ and continues the above-described position estimating operation by setting the xt′, yt′, and θt as x₀′, y₀′, and θ₀.

(c) Vehicle Position Estimating Process

A navigation system applying the vehicle position estimating unit according to the second embodiment has the same configuration as that of the navigation system according to the first embodiment shown in FIG. 3.

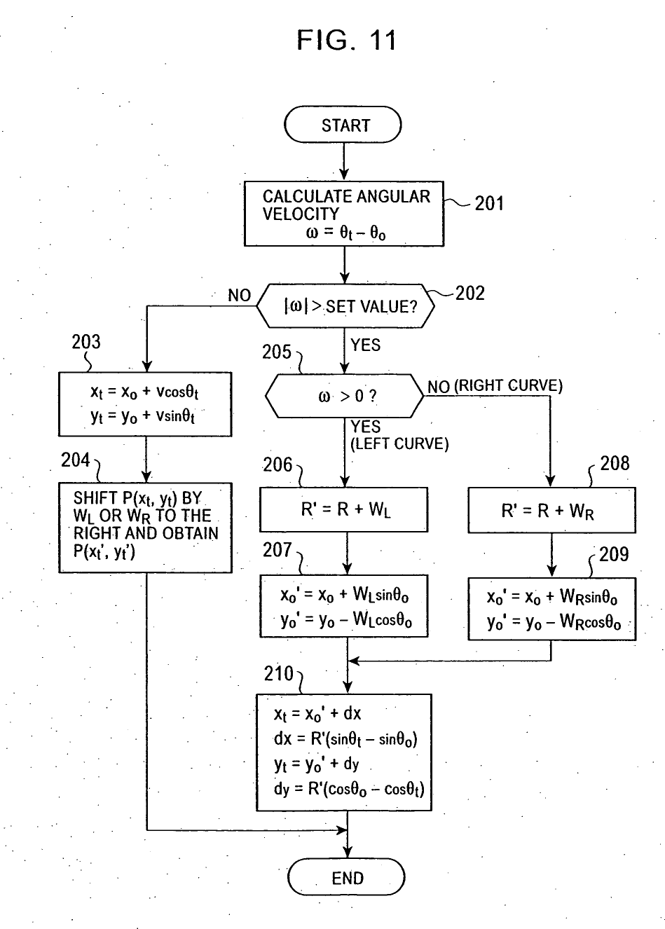

FIG. 11 is a flowchart showing a vehicle position estimating process performed by the vehicle position estimating unit 29 of the navigation system. This process can be implemented to estimate a vehicle position through a software.

The vehicle position estimating unit 29 calculates an angular velocity ω in step 201, and compares the angular velocity |ω| with a set value in step 202. If |ω| is equal to or smaller than the set value, the vehicle position estimating unit 29 determines that the vehicle is traveling straight and calculates the respective axial position coordinates xt and yt at the vehicle position Pt on the basis of expressions (8) and (9) in step 203. Then, the vehicle position estimating unit 29 shifts the vehicle position Pt (xt, yt) by WL to the right side in the traveling direction so as to calculate the vehicle position Pt′ (xt′, yt′) on the road link and outputs the calculated vehicle position in step 204. Then, the process returns to the start and estimation of the vehicle position is continued.

On the other hand, if it is determined in step 202 that |ω| is larger than the set value, the vehicle is determined to be traveling around a curve. Then, the vehicle position estimating unit 29 determines the sign of a difference ω (=θt−θ₀) between the azimuth θ₀ at the present position P₀ and the azimuth θt at the vehicle position Pt after t seconds, and determines the turning direction on the basis of the sign. For example, ω>0 means a left curve, whereas ω<0 means a right curve (step 205).

If the vehicle is traveling around a left curve, the vehicle position estimating unit 29 calculates the curvature radius R′ of the road link by using expression (10): R′=R+WL (step 206), and then calculates the vehicle position P₀′ (x₀′, y₀′) on the road link corresponding to the present position P₀ (x₀, y₀) by using expressions (14) and (15) (step 207). On the other hand, if the vehicle is traveling around a right curve, the vehicle position estimating unit 29 calculates the curvature radius R′ of the road link by using expression (11): R′ =R +WR (step 208), and then calculates the vehicle position P₀′ (x₀′, y₀′) on the road link corresponding to the present position P₀ (x₀, y₀) by replacing WL by WR in expressions (14) and (15) (step 209). Then, the vehicle position estimating unit 29 calculates the vehicle position Pt′ (xt′, yt′) on the road link by using expressions (12) and (13) (step 210). Then, the above-described process is repeated every predetermined time period so as to estimate the vehicle position.

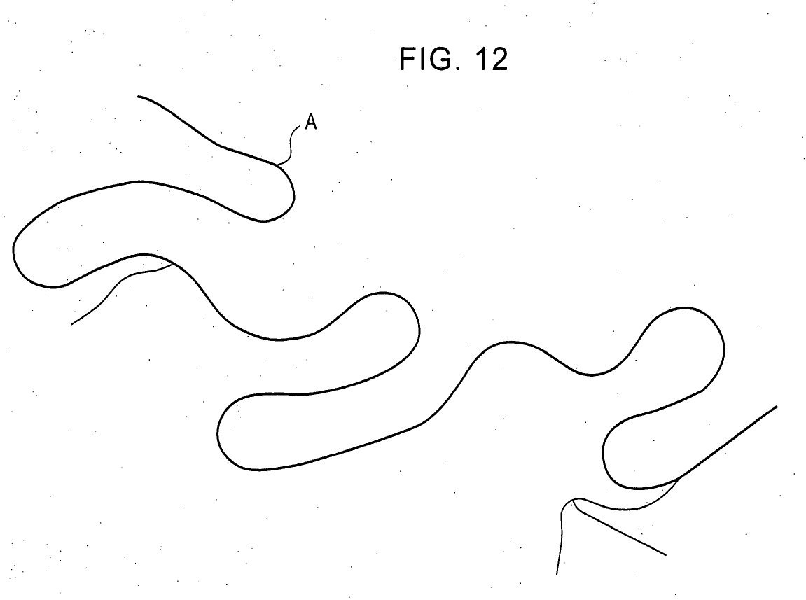

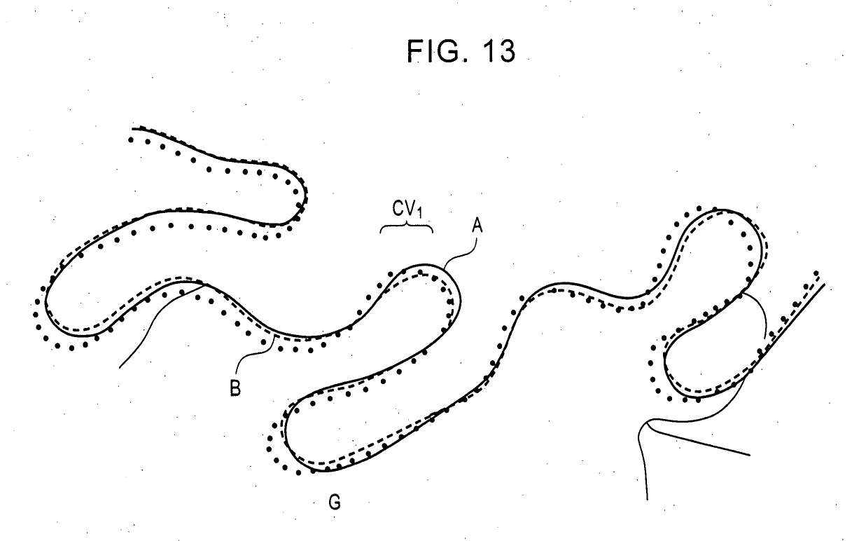

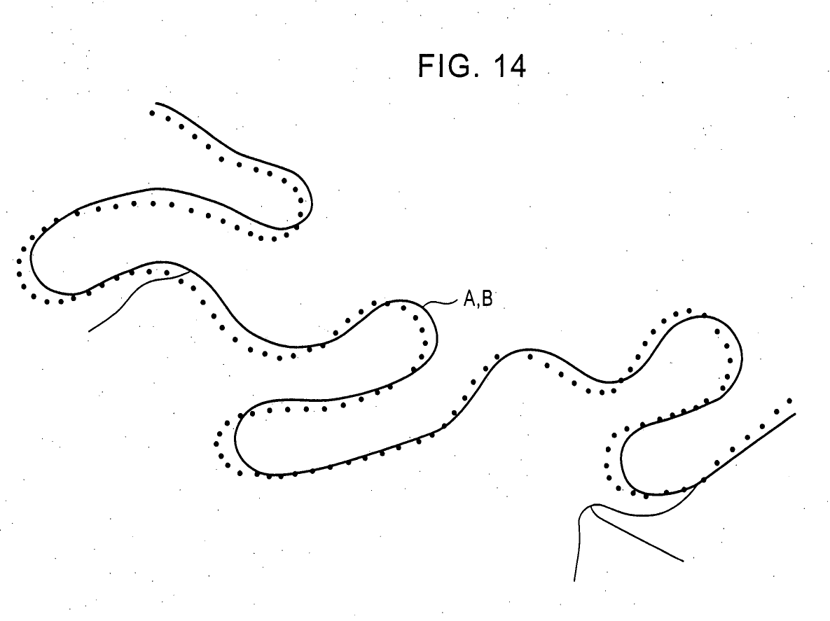

FIGS. 12 to 14 are illustrations of advantages of the second embodiment. FIG. 12 is an illustration of a winding road link A extending to the top of a mountain. FIG. 13 is an illustration of a track B generated by a map matching process using a vehicle estimation value according to the first embodiment. FIG. 14 is an illustration of a track generated by a map matching process using a vehicle estimation value according to the second embodiment. In FIGS. 13 and 14, dots G are GPS positioning points.

The vehicle estimation value according to the first embodiment shown in FIG. 13 may deviate from the road link A because the turning radius of the vehicle is different than the curvature radius of the road link shape, and thus errors in the forward and backward directions of curves due to a difference in travel distance accumulate. Particularly, the degree of deviation is significant at a curve CV1. Even if pattern matching is repeated again and again, the track B does not match the road link shape A and thus an estimated result cannot be obtained.

In the vehicle estimation value according to the second embodiment shown in FIG. 14, errors in the forward and backward directions of curves are less likely to occur because the turning radius of the vehicle is the same as the curvature radius of the road link shape and thus a difference in travel distance does not occur. As a result, the track can be matched with the road link by appropriately performing a map matching process.

According to the second embodiment, a turning direction of the vehicle is determined on the basis of a change in azimuth of the vehicle. If the vehicle turns to the left, the turning radius R is corrected so that the turning radius R becomes larger by a correction value WL. If the vehicle turns to the right, the turning radius R is corrected so that the turning radius R becomes smaller by a correction value WR. By using the corrected turning radius, a vehicle position is estimated on the center line of the road. Accordingly, the vehicle position can be estimated more accurately and a vehicle position mark can be displayed on the road link on the map.

(d) Modification

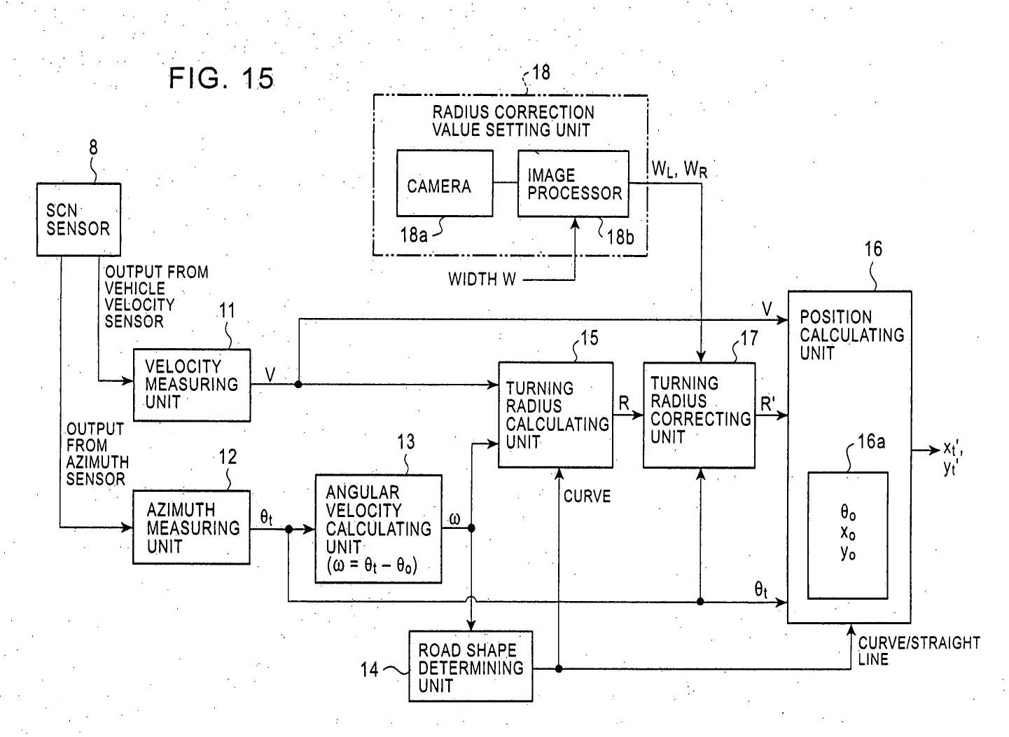

FIG. 15 shows a modification of the vehicle position estimating unit according to the second embodiment. In FIG. 15, the parts that are the same as those in FIG. 9 are denoted by the same reference numerals. The difference therebetween is the configuration of the radius correction value setting unit 18. That is, in this modification, a camera 18a to capture an image of a road is provided on the vehicle, and an image processor 18b processes the images captured by the camera 18a, so as to measure the distance between a center line of a road to a vehicle position and to output the measurement result as WR or WL. According to a principle of measuring the distance between the center line of the road and the vehicle position, (1) a road center line RCLN and a road edge LEG in the captured image is determined, as shown in FIG. 10B; (2) an image center line CL is regarded as a traveling line and a ratio a:b between the distance from the traveling line CL to the road edge LEG and the distance from the traveling line CL to the road center line RCLN is calculated; and (3) a distance d from the road center line to the vehicle position is measured in accordance with the following expression: d=(W/2)×b/(a+b) by using the ratio and the road width W obtained from link information of map data, and the distance d is output as WR or WL.

According to this modification, the distance between the road center line and the vehicle position can be accurately measured and used, so that the accuracy of estimation of the vehicle position can be increased.

### Third Embodiment

A typical navigation system is designed on the assumption that only one vehicle position is to be estimated. That is, a position on a road link obtained by map matching a vehicle position estimated by using an SCN sensor is regarded as a vehicle position. By using the vehicle position on the road link, a vehicle position mark can be displayed on the road link on a map, a distance along the road can be calculated, and route guiding can be performed. However, with this vehicle position on the road link, a vehicle position mark cannot accurately be displayed at an actual vehicle position on a road on a town map, which accurately shows even a road width. Furthermore, an actual traffic lane cannot be estimated.

In the third embodiment, a first vehicle position corrected onto a road link (road center line) and a second vehicle position on an actual traveling line are constantly calculated and managed, and a process suitable for navigation control is performed by using one of the first and second vehicle positions.

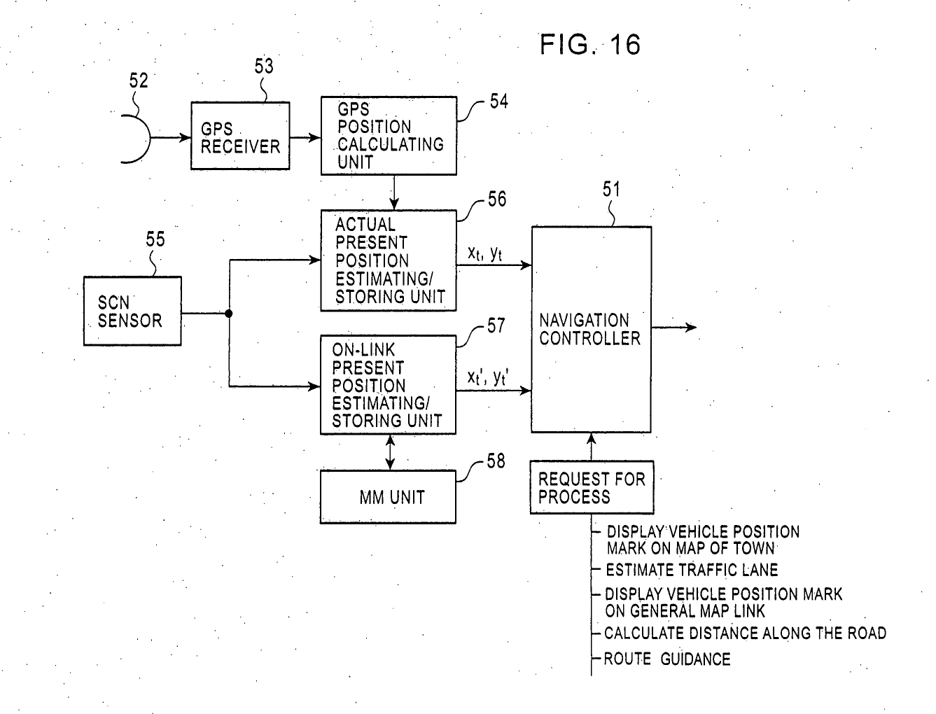

FIG. 16 is a block diagram showing a navigation system according to the third embodiment. The navigation system includes a navigation controller 51 to perform various navigation controls, a multi-beam antenna 52 and a GPS receiver 53 to receive radio waves from a GPS satellite, a GPS position calculating unit 54 to calculate a present vehicle position (GPS position) on the basis of GPS data from the GPS receiver 53, an SCN sensor 55 including an azimuth sensor (angle sensor) to detect a turning angle of a vehicle and a distance sensor, an actual present position estimating/storing unit 56 to estimate and store an actual present vehicle position, an on-link present position estimating/storing unit 57 to estimate and store a position on a road link, and a map matching unit 58 to perform a map matching process by using an on-link present position.

The actual present position estimating/storing unit 56 has the same configuration as that of the vehicle position estimating unit according to the first embodiment shown in FIG. 2, and has a function of estimating and storing an absolute actual vehicle position Pt (xt, yt) by using a turning radius R of the vehicle and of providing the vehicle position xt and yt to the navigation controller 51. Also, the actual present position estimating/storing unit 56 estimates a vehicle position by the SCN by using a GPS position calculated by the GPS position calculating unit 54 as an initial position and corrects the vehicle position as necessary by using GPS position data.

The on-link present position estimating/storing unit 57 has the same configuration as that of the vehicle position estimating unit according to the second embodiment shown in FIG. 9 or FIG. 15 and has a function of estimating and storing a vehicle position Pt′(xt′, yt′) on a road link by correcting a turning radius R of the vehicle with WL or WR and of providing the xt′ and yt′ to the navigation controller 51. The vehicle position Pt′ (xt′, yt′) on the road link is corrected by a map matching process.

The navigation controller 51 performs navigation control in response to various requests by using the actual present position Pt (xt, yt) or the on-link present position Pt′ (xt′, yt′) as necessary. For example, the navigation controller 51 uses the actual present position Pt (xt, yt) for a request for displaying a vehicle position mark on a town map or a request for determining an actual traveling lane. The navigation controller 51 uses the on-link present position Pt′ (xt′, yt′) for a request for displaying a vehicle position mark on a normal map, a request for calculating a distance along a road, and a request for a guiding route.

In other words, the navigation controller 51 performs navigation control by using the actual present position Pt (xt, yt) for a request for obtaining a vehicle position as absolute position information or by using the on-link present position Pt′ (xt′, yt′) for a request for obtaining a position on the road link corresponding to the topology of the road.

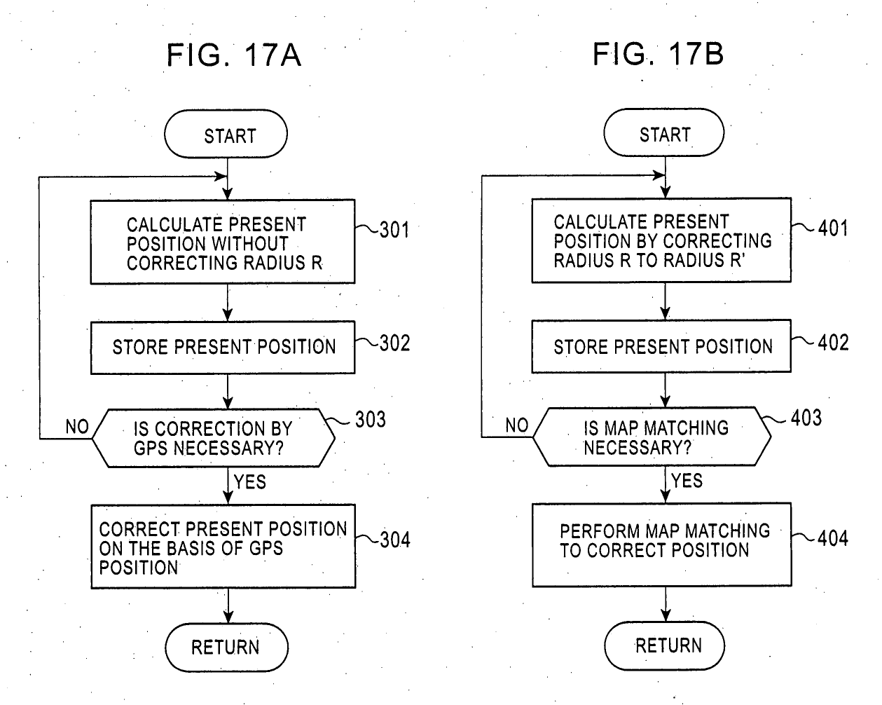

FIGS. 17A and 17B are flowcharts showing vehicle position estimating processes performed by the actual present position estimating/storing unit 56 and the on-link present position estimating/storing unit 57, respectively.

The actual present position estimating/storing unit 56 estimates a vehicle position at regular time intervals on the basis of the first embodiment (step 301). When the vehicle is traveling around a curve, an actual present vehicle position is calculated as a first vehicle position without a turning radius R being corrected. Then, the actual present position estimating/storing unit 56 stores the estimated first vehicle position (step 302), determines whether the first vehicle position needs to be corrected on the basis of the GPS position data (step 303), and repeats step 301 and the subsequent steps if the first vehicle position does not need to be corrected. If the first vehicle position needs to be corrected, for example, if errors accumulate and become significant, the actual present position estimating/storing unit 56 corrects the first vehicle position on the basis of the GPS position data (step 304) and the process returns to the start.

On the other hand, the on-link present position estimating/storing unit 57 estimates a vehicle position at regular time intervals on the basis of the second embodiment (step 401). When the vehicle is traveling around a curve, a vehicle position on a road link is calculated as a second vehicle position with a turning radius R being corrected to a link radius R′ . Then, the on-link present position estimating/storing unit 57 stores the estimated second vehicle position (step 402), determines whether a map matching process is necessary (step 403), and repeats step 401 and the subsequent steps if the map matching process is not necessary. If the map matching process is necessary, the second vehicle position is corrected on the basis of a result of the map matching process (step 404), and the process returns to the start.

According to the third embodiment, two different positions, an absolute vehicle position and a vehicle position with respect to the topology of a road, are independently estimated, managed, and used. Therefore, various navigation controls can be quickly performed with high accuracy. Specifically, the following controls can be performed:

(1) the user′ s own vehicle or other vehicles can be displayed on a lane (not at the center of a road) in a navigation screen, especially in a town map screen;

(2) a traveling lane can be accurately estimated;

(3) a distance along a road can be accurately estimated;

(4) a deviation of a vehicle position mark from a road link can be prevented;

(5) a mismatch can be prevented in map matching; and

(6) accuracy of pattern matching can be increased.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A vehicle position estimating method for a navigation system to calculate a position of a vehicle and display a map of an area around the vehicle and a vehicle position mark on a display, the method comprising:
providing a sensor to detect a travel distance of the vehicle and an azimuth of the vehicle;
calculating a turning radius of the vehicle by using a signal output from the sensor; and
estimating a vehicle position on a road link by using the turning radius.

2. The vehicle position estimating method according to claim 1, further comprising:
calculating an angular velocity of the vehicle by using a signal output from the sensor; and
calculating the turning radius of the vehicle by using the angular velocity and the travel distance.

3. The vehicle position estimating method according to claim 2, further comprising:
calculating the angular velocity of the vehicle at each of a predetermined travel time period or at each of a predetermined travel distance.

4. The vehicle position estimating method according to claim 2, further comprising:
estimating a vehicle position by determining that the vehicle is traveling straight when the angular velocity is equal to or smaller than a set value; and
estimating a vehicle position by determining that the vehicle is traveling around a curve when the angular velocity is larger than the set value.

5. The vehicle position estimating method according to claim 4, further comprising:
estimating a present vehicle position by calculating respective axial travel components along a straight or curved line of each predetermined time period and adding the respective axial travel components to respective axial components of a previously estimated position.

6. A vehicle position estimating method for a navigation system to calculate a position of a vehicle and display a map of an area around the vehicle and a vehicle position mark on a display, the method comprising:
providing a sensor to detect a travel distance of the vehicle and an azimuth of the vehicle;
determining a turning direction of the vehicle on the basis of a change of the azimuth;
calculating a turning radius R of the vehicle by using a signal output from the sensor;
correcting the turning radius R so that the turning radius R becomes larger by a correction value WL according to a traveling position on a road if the vehicle turns in a first direction and correcting the turning radius R so that the turning radius R becomes smaller by a correction value WR according to a traveling position on a road if the vehicle turns in a direction opposite to the first direction; and
estimating a vehicle position on a road link by using the corrected turning radius.

7. The vehicle position estimating method according to claim 6, further comprising:
calculating an angular velocity of the vehicle by using a signal output from the sensor; and
calculating the turning radius R of the vehicle by using the angular velocity and a travel distance of each of a predetermined time period.

8. The vehicle position estimating method according to claim 7, further comprising:
setting each of the correction values WR and WL to W/4 when a width of the road is W.

9. The vehicle position estimating method according to claim 7, further comprising:
providing a camera to capture an image of a road on which the vehicle is traveling; and
obtaining the correction values WR and WL by determining a distance from a center line of the road to a vehicle traveling position by using the image captured by the camera.

10. The vehicle position estimating method according to claim 7, further comprising:
calculating the angular velocity of the vehicle at each of a predetermined travel time period or at each of a predetermined travel distance.

11. The vehicle position estimating method according to claim 7, further comprising:
estimating a vehicle position by determining that the vehicle is traveling straight when the angular velocity is equal to or smaller than a set value; and
estimating a vehicle position by determining that the vehicle is traveling around a curve when the angular velocity is larger than the set value.

12. The vehicle position estimating method according to claim 7, further comprising:
estimating a present vehicle position by calculating respective axial travel components along a straight or curved line of each predetermined time period and adding the respective axial travel components to respective axial components of a previously estimated position.

13. A navigation processing method for a navigation system to calculate a position of a vehicle and display a map of an area around the vehicle and a vehicle position mark on a display, the method comprising:
providing a sensor to detect a travel distance of the vehicle and an azimuth of the vehicle;
estimating a first vehicle position on an actual traveling line of a road and a second vehicle position on a center line of the road by using a signal output from the sensor and storing the first and second vehicle positions; and
performing navigation control by using the first and second vehicle positions.

14. The navigation processing method according to claim 13, further comprising:
correcting the first vehicle position on the basis of a GPS position and correcting the second vehicle position on the basis of a map matching process.

15. The navigation processing method according to claim 13, further comprising:
calculating an angular velocity of the vehicle by using a signal output from the sensor;
calculating a turning radius R of the vehicle by using the angular velocity and a travel distance of the vehicle of each predetermined time period and estimating the first vehicle position on the traveling line of the road by using the turning radius R;
correcting the turning radius R so that the turning radius R becomes larger by a correction value WL according to a traveling position on the road if the vehicle turns in a first direction and correcting the turning radius R so that the turning radius R becomes smaller by a correction value WR according to a traveling position on the road if the vehicle turns in a direction opposite to the first direction, and estimating the second vehicle position on the center line of the road by using the corrected turning radius.

16. A navigation system to calculate a position of a vehicle and display a map of an area around the vehicle and a vehicle position mark on a display, the navigation system comprising:
a sensor to detect a travel distance of the vehicle and an azimuth of the vehicle;
an angular velocity calculating unit to calculate an angular velocity of the vehicle by using a signal output from the sensor;
a turning radius calculating unit to calculate a turning radius of the vehicle by using the angular velocity and a travel distance of each predetermined time period; and
a vehicle position estimating unit to estimate a vehicle position on a road link by using the turning radius.

17. The navigation system according to claim 16, wherein the angular velocity calculating unit calculates the angular velocity of the vehicle at each of a predetermined travel time period or at each of a predetermined travel distance.

18. The navigation system according to claim 17, wherein the vehicle position estimating unit estimates a vehicle position by determining that the vehicle is traveling straight when the angular velocity is equal to or smaller than a set value and estimates a vehicle position by determining that the vehicle is traveling around a curve when the angular velocity is larger than the set value.

19. A navigation system to calculate a position of a vehicle and display a map of an area around the vehicle and a vehicle position mark on a display, the navigation system comprising:
a sensor to detect a travel distance of the vehicle and an azimuth of the vehicle;
a turning direction determining unit to determine a turning direction of the vehicle on the basis of a change of the azimuth;
an angular velocity calculating unit to calculate an angular velocity of the vehicle by using a signal output from the sensor;
a turning radius calculating unit to calculate a turning radius R of the vehicle by using the angular velocity and a travel distance of each predetermined time period;
a turning radius correcting unit to correct the turning radius R so that the turning radius R becomes larger by a correction value WL according to a traveling position on a road if the vehicle turns in a first direction and correct the turning radius R so that the turning radius R becomes smaller by a correction value WR according to a traveling position on a road if the vehicle turns in a direction opposite to the first direction; and
a vehicle position estimating unit to estimate a vehicle position on a center line of the road by using the corrected turning radius.

20. The navigation system according to claim 19, further comprising:
a correction value setting unit to set each of the correction values WR and WL to W/4 when a width of the road is W.

21. The navigation system according to claim 19, further comprising:
a camera to capture an image of a road, the camera being provided on the vehicle; and
a correction value obtaining unit to obtain the correction values WR and WL by determining a distance from a center line of the road to a vehicle traveling position by using the image captured by the camera.

22. The navigation system according to claim 19, wherein the vehicle position estimating unit estimates a vehicle position by determining that the vehicle is traveling straight when the angular velocity is equal to or smaller than a set value and estimates a vehicle position by determining that the vehicle is traveling around a curve when the angular velocity is larger than the set value.

23. A navigation system to calculate a position of a vehicle and display a map of an area around the vehicle and a vehicle position mark on a display, the navigation system comprising:
a sensor to detect a travel distance of the vehicle and an azimuth of the vehicle;
a vehicle position estimating unit to estimate a first vehicle position on an actual traveling line of a road and a second vehicle position on a center line of the road by using a signal output from the sensor and store the first and second vehicle positions; and
a navigation control unit to perform navigation control by using the first and second vehicle positions on the basis of a process.

24. The navigation system according to claim 23, further comprising:
a map matching process unit to correct the second vehicle position; and
a GPS position measuring unit to measure a GPS position on the basis of a GPS signal from a satellite,
wherein the vehicle position estimating unit corrects the first vehicle position on the basis of the GPS position.

25. The navigation system according to claim 23, further comprising:
an angular velocity calculating unit to calculate an angular velocity of the vehicle by using a signal output from the sensor,
wherein the vehicle position estimating unit includes:
a first position estimating unit to calculate a turning radius R of the vehicle by using the angular velocity and a travel distance of the vehicle of each predetermined time period and estimate the first vehicle position on the traveling line of the road by using the turning radius R; and
a second position estimating unit to correct the turning radius R so that the turning radius R becomes larger by a correction value WL according to a traveling position on the road if the vehicle turns in a first direction and correct the turning radius R so that the turning radius R becomes smaller by a correction value WR according to a traveling position on the road if the vehicle turns in a direction opposite to the first direction, and estimate the second vehicle position on the center line of the road by using the corrected turning radius.
